(19) United States
(12) Patent Application Publication
(10) Pub. No.: US 2015/0095399 A1
(43) Pub. Date: Apr. 2, 2015

(54) METHOD OF PASSIVE COMMUNICATION FOR LOCATION BASED NETWORKS

(71) Applicant: 2391104 Ontario Inc., Ottawa (CA)

(72) Inventors: David Mohajer Va Pesaran, Ottawa (CA); Semchuddar Ponnambalam, Ottawa (CA)

(21) Appl. No.: 14/496,849

(22) Filed: Sep. 25, 2014

Related U.S. Application Data
(60) Provisional application No. 61/883,887, filed on Sep. 27, 2013.

(51) Int. Cl. H04L 29/08

(52) U.S. Cl. CPC H04L 67/18; H04L 67/10
USPC 709/202

(57) ABSTRACT

The present invention provides a method for one or more subscribers to anonymously send a pull request to a server having the following steps: authenticating, by a gateway server, one or more subscribers; and evaluating, by a context server, a request by a subscriber, the evaluation having the following steps: reconciling the service type of the request; reconciling one or more groups associated with the request; retrieving and selecting data elements based on the service type data and the one or more groups, the data elements populated by the one or more other subscribers including subscriber location and subscriber transmission range of the one or more other subscribers; and providing the relevant data elements to the subscriber making the request if subscriber listening range, defined by the subscriber, overlaps with the transmission range of the relevant data elements, specified by the one or more other subscribers for each corresponding data element.

### CROSS-REFERENCE TO RELATED APPLICATIONS

This U.S. Non-Provisional Utility patent application claims the benefit, under 35 U.S.C. §119, of U.S. Provisional Patent Application No. 61/883,887 filed Sep. 27, 2013 the contents of which are incorporated herein by this reference in its entirety.

### FIELD OF THE INVENTION

The present invention pertains to the field of electronic networking and in particular to proximity based social networks.

### BACKGROUND

The need for proximity based information is desirable for a number of applications. However fine control of content distribution and anonymity remain challenges for current systems. Furthermore, the sensitivity of location is also important in some embodiments for the merit of such a system.

Therefore there is a need for a solution which provides for a new paradigm of proximity based social networking which provides for anonymous distribution with advanced user based controls for content.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method of passive communication for location based networks. In accordance with an aspect of the present invention, there is provided a method for one or more subscribers to anonymously send a pull request to a server having the following steps: authenticating, by a gateway server, one or more subscribers; and evaluating, by a context server, a request by a subscriber, the evaluation having the following steps: reconciling the service type of the request; reconciling one or more groups associated with the request; retrieving and selecting data elements based on the service type data and the one or more groups, the data elements populated by the one or more other subscribers including subscriber location and subscriber transmission range of the one or more other subscribers; processing the data elements with a database, processing including comparison analysis between data elements within said database; and providing the relevant data elements to the subscriber making the request if subscriber listening range, defined by the subscriber, overlaps with the transmission range of the relevant data elements, specified by the one or more other subscribers for each corresponding data element.

In accordance with another aspect of the present invention, there is provided a method for one or more subscribers to anonymously send a push request to a server having the following steps: authenticating, by a gateway server, one or more subscribers; and evaluating, by a context server, a request by a subscriber, the evaluation having the following steps: reconciling the service type of the request; reconciling one or more groups associated with the request; retrieving and selecting data elements based on the service type data and the one or more groups from the request, the data elements including subscriber location and subscriber transmission range defined by the subscriber; processing the data elements with a database, processing including comparison analysis between data elements and information within said database; and updating the database with the processed request.

### BRIEF DESCRIPTION OF THE FIGURES

FIG. 1 illustrates an example of one of the possible employed methods of pulling a request from a server;

FIG. 2 illustrates an example of one of the possible employed methods of pushing a request to a server;

### DETAILED DESCRIPTION OF THE INVENTION

### Definitions

As used herein, the term “device” may be defined as any apparatus capable of network access. The device may be wired or wireless. In some embodiments, the device may include a personal computer, tablet, mobile device, mobile phone, television, music player, personal organizer, or any similar electronic network enabled device. In some embodiments, the subscriber device may be wearable technology including, but not limited to, jewelry, watches, glasses, hats, clothing, shoes, socks—essentially anything that is placed on or in a person which includes network enablement. In at least one embodiment, the subscriber device may include an interface for accepting credit card payment or debit payments at a business for example. In at least one embodiment, the device may function autonomously with pre-set configurations.

As used herein, the term “message” may be defined as a structured set of information that may include, but is not limited to, location based data, some combination of categories, a description, tags, and other details appropriate for parsing.

As used herein, the term “push” in the context of subscriber activities may be defined as the subscriber sending structured data to the electronic platform within the appropriate superstructure.

As used herein, the term “pull” in the context of subscriber activities may be defined as the subscriber retrieving data from the electronic platform within the appropriate superstructure using a structured data request.

As used herein, the term “subscriber push and pull” and “subscriber pull and push” both may be defined as a combination of “subscriber push” and “subscriber pull” wherein neither behavior is predicated on the other, but both are possible for that particular context.

As used herein, the term “superstructure” may be defined as a structured set of servers that provides one or more subscriber services. The superstructure is configured in a way to provide services to a subgroup of all of the subscribers of this service. A superstructure can exist within, but not limited to some combination of one or more of the following: the worldwide internet, a local area network (LAN), a wide area network (WAN), a cellphone data or GSM/CDMA network, and other similar networks that can implement TCP/IP and or any other communication between mobile devices known in the art.

As used herein, the term “gateway server” refers to, but is not limited to, structured hardware and software processes which evaluate incoming network traffic for one or more superstructure.

As used herein, the term “tag(s)” may be defined as a set of options selected by, but not limited to, subscribers, administrators and semi or automated structured processes. Tags may be an alpha-numeric string added to a discrete section of a message. The tags themselves provide for filtering used to the data retrieval and processing stages to refine the response or storage of information. In at least one embodiment, this includes meta-level data modification (changing range of a transmission or listening distance), or filtering the text sent using a special key (auto converting to Pig Latin for example).

As used herein, the term “subscriber” may be defined as any entity that is able to authenticate to the gateway server. Types of subscribers may include, but are not limited to, devices, applications, and persons. An individual subscriber may use structures. An individual subscriber may be a member of one or more of the following: a Person, Business, Government, or an automated system that disseminates and collects data from the internet and other autonomous and semi-autonomous entities.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

### Methodology Summary

The present invention provides a method of passive communication over a location based network namely, a method for one or more subscribers to send a request, or retrieve a request, for a service to a server based on subscriber location and subscriber listening/transmission range, where these values are set by the subscribers. Additionally, in at least one embodiment, parameters in the form of tags may be specified as part of the sending or retrieving of requests.

In at least one embodiment, a subscriber might want to communicate with various subscribers within a short range of their geo-spatial location using a configurable distance to retrieve messages to allow others to retrieve their messages, and categorize selections based on context and within a specific network based on a higher level context. Additionally, customized versions of the system can be produced to allow specific subscriber groups to have privileged access to a private location, radius and context based passive communication network via mobile device. The messages would be pushed onto the servers, and retrieved by pulling messages from the servers.

The determination of proximity for the subscriber may be accomplished by any means known in the art. This includes, but is not limited to, GPS, utilizing IP address, triangulation methods, data cell tower triangulation, and other proximity determining means readily understood by a person skilled in the art. These methods may be employed on the subscriber device. For example, many varieties of mobile devices include a GPS as well as having a constant internet connection allowing for IP address verification. In some embodiments, multiple methods may be utilized for accuracy; for example GPS used in conjunction with an IP address. This can be done in multiple ways that include, but are not limited to, the following: comparing differences in subscriber geo-spatial positions using transmission and listening ranges, the use of tags tied to geospatial locations, vectors of movement restricting or increasing listening and transmission ranges accordingly to account for time lapse between pull requests.

In at least one embodiment, the subscriber defines two variables by utilizing their proximity. Firstly, the subscriber defines their listening range which determines how far the subscriber wishes to search or receive specified messages based on their current determined proximity. Secondly, the subscriber defines their transmission range which determines how distant their messages are sent relative to their current determined proximity. Each of these variables is adjusted by the subscriber to calibrate how far information is sent and also how much information is retrieved.

In at least one embodiment, the information retrieved based on proximity does not identify the subscriber who published the information. In this fashion, the information is anonymous to prevent any other subscriber from knowing the source of the information.

In at least one embodiment, the information retrieved based on proximity does not identify the subscriber who published the information, however the server administrators retain a subscriber indicator which identifies the subscriber to the electronic platform. This subscriber indicator is not shared with any other subscriber on the electronic platform, but rather is used as an administrative identifier by the administrator to identify the subscriber. Therefore the subscriber retains anonymity, while still conceding their identification to the administrators.

### Platform Integration

In at least one embodiment, the method may be implemented by means of a social network. The social network is implemented as an electronic platform by means of a software application. The above mentioned subscriber devices interact with platform hardware and software to fully execute the electronic platform.

The electronic platform may be implemented by any means known in the art including local installation of a software application on a mobile device with minimal retrieval of extraneous data from server. In at least one embodiment, the software application is a “thin client” on the subscriber device and retrieves substantial amounts of information from server. In at least one embodiment, the software application is accessed through a network client (e.g., web browser, third party aggregator application). In at least one embodiment, the implementation of the application may include a hybrid of conventional paradigms such as those described above.

The electronic platform includes a gateway server and a context server. In some embodiments, these servers are discrete pieces of hardware, in other embodiments, the servers are located on the same hardware.

The gateway server evaluates incoming network traffic for one or more superstructures and performs authentication for the one or more subscribers. One or more context servers are specific to the requested type of information and may be classified such that a type of information is contained within a discrete context server. This may contemplate third parties providing proprietary context servers for specific services.

A database is utilized to store all messages transmitted by the one or more subscribers. The information may be routed to the one or more context servers based on classification and or tags. Each message stored in the database is provided by the one or more subscribers with a corresponding transmission distance and a base location. Therefore, each message is associated with a geo-spatial location and permeates a corresponding radial distance based on the subscriber's defined transmission distance associated with the message.

In at least one embodiment, only the subscriber who makes the “push request” to the platform may specify the transmission distance of the message. It is contemplated that each message may be given a different transmission distance defined at each instance of new information.

In at least one embodiment, the subscriber making the “push request” may allow a third party to set the transmission distance of the message. For example, if the subscriber is at a concert, a third party (e.g., concern administrator) may pre-define the transmission distance of all “push requests” for a defined tag (e.g., #rockconcertVancouver). This may also include a defined point of propagation with a defined radius (e.g., center stage radiating outward).

Each subscriber may be eligible to view the information provided by the one or more subscribers if the subscriber making the pull-request has a proximity within the pre-defined listening range associated with each message. Therefore a relative proximity comparison is conducted between the pull-request and the proximity associated with the message.

The information on the database may be managed in various methods. In at least one embodiment, the information is managed by means of a stack system in that the most recent message is placed on top of the stack. The secondary filter of listening range reduces the total stack into a filtered stack. Further filters such as the implementation of tags or search may narrow the retrieved stack further.

In at least one embodiment, the information may be managed by popularity of retrieval by the one or more subscribers. In at least one embodiment, the information may be managed by preferred subscribers given the frequency of push requests made within a vicinity, as to grant them preferred status.

In at least one embodiment, the listening radius of the information being retrieved may be scaled with the vector of the subscriber making the pull request coupled with the frequency of their pull requests in relation to the vectors of the other subscribers who have made push requests coupled with the frequency of their push requests. Therefore, if a subscriber who may have specified a listening range, moves out of the radius of the transmission range of another/other subscribers before pulling a request for messages from the server, that pulling subscriber may be able to receive a message pushed while they were still approximately within range of the other subscribers that sent the messages if the pulling subscriber meets a pre-defined threshold. The threshold may be determined by the administrator of the electronic platform, or in some embodiments by the subscribers.

### Pull Request Embodiment

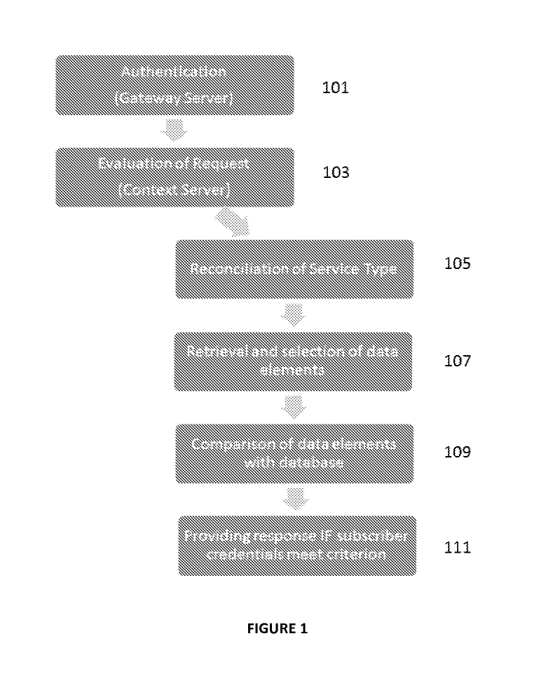

FIG. 1 illustrates a flowchart of an example of one of the possible employed methods of pulling a request from a server. A subscriber may pull information from the platform when the subscriber making the pull request has their defined listening range overlap with the message's corresponding transmission range; and where the transmission range for the message is defined by the subscriber who pushed the message.

Initially, the subscriber authenticates with the gateway server (101). In at least one embodiment, there are multiple layers to the authentication stage. A layer 1 authentication is structured as a type of overload protection. A minimum information check is conducted from the subscriber to the gateway server to measure the elapsed time between subsequent pull requests from the same subscriber. This check utilizes the minimum amount of transmission information to conduct the overload protection check. The allowable relative time period is set by a pre-determined threshold configurable by the gateway server. If the time elapsed between pull requests is less than the pre-defined threshold, then the request is denied by the gateway server. Otherwise, if the time elapsed is greater than or equal to the pre-defined threshold, the subscriber is passed to layer 2 of the authentication process.

Layer 2 of the authentication process verifies the credentials of the subscriber using means known in the art. For example, the subscriber's unique identifier and security keys are verified.

Once authenticated with the gateway server, the subscriber proceeds to the evaluation stage (103) of the pull request process. This stage comprises four sub-stages allowing for a determination of the type of pull request and the appropriate retrieval of relevant data and provides the desired information applied for by the subscriber.

The request made by the subscriber is then analyzed to determine the service type and group type (105). Initially a determination is made as to the service type. This information is embedded in the request data. Service types may include, but are not limited to, pulling a message, requesting a customized report on location based data, (push and pull) subscriber acting as bridge between technologies in order to disseminate information back and forth, auto and semi-automated reporting based on environment which may be relative to subscribers. The specific variety of service type may necessitate a rerouting of the request to a specific server designed to handle the specific variety of service type. In at least one embodiment, the specific server is a context server. Moreover, this embodiment allows for third party servers to integrate with the described configuration such that if a request is made for the third party service, the method would at this stage reroute the request to a third party context server.

Once the request has been classified and routed to the appropriate server, the method then retrieves and selects the appropriate data elements (107) from the request made by the subscriber. The data retrieval examines all types of subscriber specific parameters including, but not limited to, geospatial information, group selections, search selections, reporting options, and tags. Optionally, the request is also filtered based on group type. A group may include any term utilizing by any subscriber for which serves as a common theme. Groups may be expressly created or may be implicitly aggregated through a common search term or tag. This allows for a push request to be classified based on the express designation or tag classification (implicitly searching the request). In at least one embodiment, the subscriber may configure his settings such that the request cannot be searched for tags, while in other embodiments the converse may be true where the requests may be searched for tags.

The term “tag”, as defined previously, refers to structured settings selected by the subscriber initiating the request to the server, an administrator of but not limited to a superstructure, a specific service, or a subscriber group, or even some backend service that determines that a specific subscriber has selected a subset of the aggregate information stored on the database. For example, a subscriber purchases a license for extended range communication, this tag would then be located during the data retrieval stage when the request data is analyzed for the subscriber by the servers. Another tag could be specified by the subscriber to provide a tag during the request that identifies the pull as a “numbers only message” so that only numbers are returned by the servers.

Retrieving the relevant data elements, the method then compares the retrieved data elements to a database to match the data elements of the pull request to corresponding information on the database (109). For example, the subscriber has specified in the request that their listening range is of a subscriber-defined value. This subscriber-defined value is utilized as a filter when compared to the database such that only information in the database respecting the listening range is ascertained. Further filtering is done as other data elements are added for the comparison stage.

Once the comparison is complete, if there is relevant information which meets all data elements of the subscriber's request, then the information is retrieved and returned to the subscriber (111). The return of the information may be done in a variety of fashions. In at least one embodiment, the information is sent to the subscriber's local device and stored on the subscriber's local device. In at least one embodiment, the information is stored on the server and only the index is sent to the subscriber with each selection resulting in local storage of the information. In at least one embodiment, the information and index are stored on a server with the subscriber's device accessing both the information and the index via the network.

The format of the data returned follows a pre-defined structure. Configured structure may be configured by the context server or the subscriber. For example, a message pull would be structured with a group, a name, a date and a message, whereas a report might be structured as a special binary file.

### Push Request Embodiment

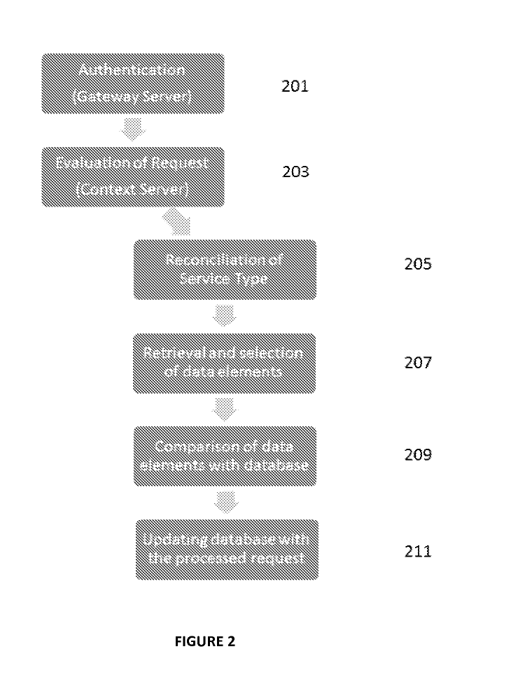

FIG. 2 illustrates a flowchart of an example of one of the possible employed methods of pushing a request to a server. A subscriber may push information from the platform whereby the subscriber sets preferences with respect to their transmission range such that a filter is put on the spread of information stored by the platform and other subscribers may access the information based on their listening range being set to overlap the information provider's transmission range.

In similar fashion to the above described pull request, initially, the subscriber authenticates with the gateway server (201).

Similar to the above described push request, in at least one embodiment, there are multiple layers to the authentication stage. A layer 1 authentication is structured as a type of overload protection. A minimum information check is conducted from the subscriber to the gateway server to measure the elapsed time between subsequent push requests from the same subscriber. This check utilizes the minimum amount of transmission information to conduct the overload protection check. The allowable relative time period is set by a pre-determined threshold configurable by the gateway server. If the time elapsed between push requests is less than the pre-defined threshold, then the request is denied by the gateway server. Else, if the time elapsed is greater than or equal to the pre-defined threshold, the subscriber is passed to layer 2 of the authentication process.

Layer 2 of the authentication process verifies the credentials of the subscriber using means known in the art. For example, the subscriber's unique identifier and security keys are verified.

Once authenticated with the gateway server, the subscriber proceeds to the evaluation stage (203) of the push request process. This stage comprises four sub-stages allowing for a determination of the type of push request and the appropriate retrieval of relevant data and provides the desired information applied for by the subscriber.

The request made by the subscriber is then analyzed to determine the service type and group type (205). Initially a determination is made as to the service type. This information is embedded in the request data. Service types may include, but are not limited to, pushing a message, requesting a customized report on location based data, (push and pull) subscriber acting as bridge between technologies in order to disseminate information back and forth, auto and semi-automated reporting based on environment which may be relative to subscribers. The specific variety of service type may necessitate a rerouting of the request to a specific server designed to handle the specific variety of service type. In at least one embodiment, the specific server is a context server. Moreover, this embodiment allows for third party servers to integrate with the described configuration such that if a request is made for the third party service, the method would at this stage reroute the request to a third party context server.

Once the request has been classified and routed to the appropriate server, the method then retrieves and selects the appropriate data elements (207) from the request made by the subscriber. The data retrieval examines all types of subscriber specific parameters including, but not limited to, geospatial information (e.g., barometric pressure, temperature, wind speed, lumens of immediate geospatial environment), group selections, search selections, and reporting options. Optionally, the request is also filtered based on group type. A group may include any term utilizing by any subscriber for which serves as a common theme. Groups may be expressly created or may be implicitly aggregated through a common search term or tag. This allows for a push request to be classified based on the express designation or tag classification (implicitly searching the request). In at least one embodiment, the subscriber may configure his settings such that the request cannot be searched for tags, while in other embodiments the converse may be true where the requests may be searched for tags.

Retrieving the relevant data elements, the method then compares the retrieved data elements to a database to match the data elements of the request to corresponding information on the database (209). For example, the subscriber has specified in the request that their transmission range is of a subscriber-defined value. This subscriber-defined value is utilized as a filter when compared to the database such that only information in the database respecting the listening range is ascertained. Further filtering is done as other data elements are added for the comparison stage.

Once the comparison is complete, if there is relevant information which meets all data elements of the subscriber's request, then the information is retrieved and returned to the subscriber (211). The return of the information may be done in a variety of fashions. In at least one embodiment, the information is sent to the subscriber's local device and stored on the subscriber's local device. In at least one embodiment, the information is stored on the server and only the index is sent to the subscriber with each selection resulting in local storage of the information. In at least one embodiment, the information and index are stored on a server with the subscriber's device accessing both the information and the index via the network.

The format of the data returned follows a pre-defined structure. Configured structure may be configured by the context server or the subscriber. For example, a message push would be structured with a group, a name, a date and a message, whereas a report might be structured as a special binary file.

The invention will now be described with reference to specific examples. It will be understood that the following examples are intended to describe embodiments of the invention and are not intended to limit the invention in any way.

### EXAMPLES

### Example 1

This example is illustrative of an electronic platform implementation. Jason downloaded the electronic platform by means of an electronic application through a mobile platform loading the application on his mobile smartphone.

Jason is attending an outdoor food festival held outdoors on city property in Los Angeles Calif. Jason has a preference for Asian cuisine and makes a pull request to the platform sending the following request using his mobile device with the following data elements:
Tags: #FoodFest2013, #LA #AsianCuisine
Listening Range: 2 km radius

Jason is given a list of the most relevant results arranged by recent activity with one or more other subscribers posting message to the platform which are in compliance with the filters specified by the request. The message is displayed if the one or more subscribers messages have a geo-spatial post within a 2 km radius of Jason as well as have the requisite tags specified above.

Jason sorts through the information to find a response with the following data elements:
Description: “The Scrappy Panda, at stall 23B makes the best egg rolls ever”
Tags: #FoodFest2013, #LA #AsianCuisine #23B #eggrolls #TSP
Transmission Range: 3 km radius

Jason now retrieves this information to determine what festival attendees opinions are with respect to Asian cuisines.

### Example 2

This example is illustrative of an electronic platform implementation. Katrina accesses the electronic platform by means of her “smart-glasses” (wearable technology allowing for network access through optical glasses).

Katrina is visiting New York City for the first time and wishes to see what is happening along the corner of 5^{th} Avenue and 47^{th} Street as she goes for a walk along this path. Katrina's glasses record her request for a pull request with the following data elements:
Tags: #5thavenue
Transmission Range: 400 m radius

Katrina is shown the most recent push requests made by the one or more other subscribers with the tag “#5thavenue”. Katrina is shown a number of subscriber posted information regarding great cafes, discounted Broadway shows, an owner looking for a missing cat, advertisement for a street show later tonight at this corner, etc.

Katrina goes into a nearby café upon recommendation from one of the push requests. She finds the sandwiches so remarkable she makes a push request of herself with the following data elements:
Description: “Grilled cheese—perfection at Lou's Café on 5th”
Tags: #Lous, #5thavenue #grilledcheese #iloveNYC
Transmission Range: 1 km radius

### Example 3

This example is illustrative of an electronic platform implementation. Leonardo accesses the platform using the web application on his tablet. Leonardo is a passenger in his brother's car on his way to his friend's house.

Leonardo is searching for any information with respect to the current geo-spatial location. The application is configured by Leonardo such that the retrieved push request information is constantly updated with respect to Leonardo's current geo-spatial location. Leonardo's pull request has the following data elements:
Transmission Range: 10 km radius

Leonardo finds the following push request send by a subscriber:
Description: “License Plate BIEM 384 left tail light is not working”
Tags: #BIEM384 #taillight
Transmission Range: 20 km radius

Leonardo realizes this is his brother's car information and notifies his brother and they pull into the closest garage to remedy the safety hazard associated with the deficient tail light.

### Example 4

This example is illustrative of an electronic platform implementation. A subscriber is a food service truck with an automated system tied into the trucks navigation system and a database on the truck that has menu and operating information. This truck system will push messages automatically based on an interval set by the food truck service.

When the truck stops somewhere for more than 1 minute and it will automatically push, to the electronic platform, the details where the truck is located.

The truck periodically announces the menu and operating information, as well as its location through a push request to the electronic platformin a push request with the following details:
Description: “At King & Bay—open at lunch, all burgers $5, combo $10”
Tags: #BayStreetBurger Wood #cheapeats #lunch
Transmission Range: 2 km radius

### Example 5

This example is illustrative of an electronic platform implementation. Tom is driving to a rock concert featuring his favorite band with his friend John in the passenger seat. John is the subscriber, using a cell phone to access the electronic platform.

John's cell phone executes periodic pull requests with the following details:
Tags: #nearbyparking
Transmission Range: 1 km

John receives messages indicating parking lot space availability pushed to the electronic platform by a parking attendant administrators.

### Example 6

This example is illustrative of an electronic platform implementation. Patricia is the subscriber using a laptop to access the electronic platform in her livingroom.

Patricia wants to organize an ad-hoc block party in her neighborhood. Since she does not know everyone, she decides that the best way is to reach out by pushing messages to the general tag (e.g., no tag) with a transmission radius of 1 km, indicating her intent. Even though the message is anonymous, Patricia expressly put her personal information embedded in the message with the following details:
Description: “Hey Guys! It's Patricia organizing a block-party tonight! Come on out and join the fun! Let me know what time works best”
Tags: #KingStreetBlockParty #fun #party
Transmission Range: 1 km radius

At regular intervals, Patricia's laptop sends pull requests to the electronic platform to retrieve messages with a listening radius of 1 km. Occasionally she will send push requests as she has a slow passive discussion with her surrounding neighbors until they reach a general consensus on the time and general parameters of the block party.

### Example 7

This example is illustrative of an electronic platform implementation. Cheryl is shopping for vegetables at a farmers market that spans a couple of blocks in a busy suburb in Crystal City, Va.

Cheryl sends a pull request to the electronic platform with the following details:
Tags: #freshvegetables #rootvegetables
Transmission Range: 2 km radius

Cheryl receives messages that were pushed to the electronic platform by the nearby subscribers who are the vendors at the farmers market. An example of a pulled message may read as follows:
Description: “Fresh Potatoes, Beets, Carrots at 4^{th} and Medina beside the fire hydrant!”
Tags: #freshvegetables #potatoes Wood #produce
Transmission Range: 1 km radius

### Example 8

This example is illustrative of an electronic platform implementation. Courtney is on a two week long cruise through the Bahamas and wants to communicate with her fellow shipmates. But they do not have internet or cell phone service on the boat. However they do have a superstructure licensed for use for the electronic platform on the boat.

Courtney acquires the software to access the boats superstructure, and then proceeds to install it on her tablet. Courtney does not want to talk in person with her cruise mates, as she is shy and wants to simply talk with them anonymously.

Courtney then decides to access the ships superstructure with her tablet and send a push request to the ships server with the following details:
Description: “Does anyone know any good shops at the next port of call?”
Tags: #ocean #cruise
Transmission Range: 1 km radius

From there she interacts passively with her cruise mates without alerting them to her specific identity, maintaining her anonymity and allowing her to safely interact with her cruise mates.

### Example 9

This example is illustrative of an electronic platform implementation. Bradley is at a folk festival and is using his smartphone to access the internet and electronic platform.

Bradley wants to know what the lineups are like so he sends a pull request to the platform with the following details:
Tags: #lineup #lineups
Transmission Range: 5 km radius

He then receives messages from the platform that were pushed by subscribers that are counting and or estimating the people in each line and sending push requests with that information to the electronic platform periodically.

### Example 10

This example is illustrative of an electronic platform implementation. Jennifer is a paramedic and is a passenger in an ambulance heading to the scene of an emergency call.

Jennifer decides that she needs to let people in the immediate vicinity know that something has happened at this location. She prepares a push request to the platform containing the following details:
Description: “Accident at intersection 23^{rd} street and hawthorn—take detour if you can”
Tags: #nearbyaccidents #emergency
Transmission Range: 20 km radius

Upon arriving at the scene of the accident, Jennifer executes the push request to the electronic platform in order to lock in the correct geospatial coordinates for the push request she is sending to the electronic platform.

The 20 km radius will allow people commuting nearby to possibly receive the message from a pull request to the platform and to avoid that area as it will be congested with traffic.

Furthermore, the electronic platform is configured such that enforcement authorities may receive priority status on their messages keeping them on top of the stack for a temporary duration based on the event. In this case, the push request will be on top of the stack for the duration of the journey of the ambulance.

### Example 11

This example is illustrative of an electronic platform implementation. Reginald is at a theme park with his family, and wants to know what the closest photo opportunity with a theme park character is available.

Reginald sends a pull request to the platform with the following details:
Tags: #photos
Transmission Range: 100 m radius

Reginald then receives messages pushed to the electronic platform by other subscribers, likely the theme park characters themselves or the other actors at the theme park managing and or assisting them. The messages received contain the information that Reginald was looking for and he proceeds to direct his family to the specified locations mentioned in the pulled messages.

### Example 12

This example is illustrative of an electronic platform implementation. Mark is a park ranger at a large provincial park in Ontario, Canada. Mark is equipped with his smartphone and the software that allows him to connect to the electronic platform and designated Park organized superstructure.

Mark spots a family of black bears heading north and decides to send out a message passively warning people within 5 km that a family of black bears has been spotted and which direction they were headed. He sends a push request with the following details:
Description: “WARNING! A family of black bears has been spotted heading north near the old Alpine trail—there are four bears in total, with one adult”
Tags: #parkranger #bear #advisory
Transmission Range: 20 km radius

### Example 13

This example is illustrative of an electronic platform implementation. Stephen is a safety conscious hunter and is out hunting deer and does not want to get too close to other hunters. Utilizing his smartphone, Stephen sends a push request to the electronic platform with the following details:
Description: “Hello out there, I am hunting here!”
Tags: #imhuntinghere #hunting #deer
Transmission Range: 2 km radius

Stephen sets this message on auto repeat at 30 second intervals in order to ensure that anyone else in the vicinity will be aware of his presence in that area and act accordingly.

### Example 14

This example is illustrative of an electronic platform implementation. Frank is a university student who wants to organize an ad-hoc study session but does not know his fellow students.

Frank loads up his laptop and acquires the software for accessing the platform. Frank then sends a push request with the following details:
Description: “I'm going to the main library on campus tonight at 10 pm to review calc2001 midterm example if anyone else wants to come let's do this!!”
Tags: #CALC2001
Transmission Range: 50 km radius

Other subscribers who are monitoring the tag #CALC2001 will then receive Frank's message when they execute pull requests to the electronic platform with the tag #CALC2001, if they are within the transmission range, and that range is within their listening ranges.

### Example 15

This example is illustrative of an electronic platform implementation. Harry is a nurse at a refugee camp accessing a mobile superstructure where the servers are located in multiple trucks that can move when the camp moves and sprawls over multiple kilometers of space as needed by the size of the camp.

Harry wants to find out if anyone has any extra gauze but does not have the luxury of running to one of the other nurse stations himself and volunteer couriers (runners) are a scarce resource. Harry is tied up with bandaging wounds. He takes a moment to send a push request to the mobile superstructure with the following details:
Description: “We are going to run out of Gauze at nurse station 3 in about two hours, does anyone have an extra case?”
Tags: #supplies
Transmission Range: 10 km radius

### Example 16

This example is illustrative of an electronic platform implementation. A corporation who is looking to setup local events in multiple cities for a new ad campaign launch might be executing a multi-faceted research approach that includes the usage of the electronic platform in order to gather cogent data.

The corporation in this case, would have a license that allows them to send pull requests to the server with “special tags” that contain parameters and settings for the retrieval of customized reports on geo-spatial areas that includes text and location data. The electronic platform is configured such that these “special tags” are denoted with dual hash symbols as a prefix to the tag.

In this case, an employee of the corporation, Arnold, who is using a desktop computer, is tasked by management to research Montreal. The corporation wants to know how often, and where, people are talking about ice cream so he submits the following push request for a report:
Tags: ##searchreport
   ##searchwords: “ice cream; icecream; ice-cream”
Transmission Range: 30 km radius
Transmission Point: 45° 28′ N 73° 45′ W

The results that Arnold receives are contained in a structured binary output that can be read by the software on Arnold's computer showing the intensities of conversations happening around Montreal centered on the approximate center of Montreal radiating outwards 30 kilometers. Arnold takes this data to management, and it becomes part of a data set for a planning exercise for a guerilla marketing strategy promoting their new product launch of a new ice cream flavor.

### Example 17

This example is illustrative of an electronic platform implementation. Andrew is at Sea World in San Diego, Calif., and wants to figure out what the most exciting attractions are and what he should be going to see.

Andrew decides to send a pull request to the server with a special tag setting indicating the data retrieved will be formatted in a certain fashion:
Tags: ##aggregation
   ##alltags
   ##timesearch:“30 m”
   ##searchinterval:“1 m”
Transmission Range: 1 km radius

Andrew then receives a list of each all of the tags in the vicinity from the last 30 minutes, beside each is the total number of times a subscriber sent a push request to the platform to store a message under that tag, this list is sorted from most messages pushed to least.

### Example 18

This example is illustrative of an electronic platform implementation. Matthew is a government employee in Honolulu, Hi. in charge of creating public interest in beaches and wants to determine varying conditions for surfing for the local beaches.

Matthew then sets up sensors at regular intervals along the areas designated as surfing areas by the city. These sensors detect water flow speeds, wind speeds, temperature and other environmental data.

The data is automatically, without intervention by humans, sent via push requests to the platform on a 30 second interval containing all of the environmental data, the time of day, etc. The push request for these intermittent reports has the following details:
Tags: ##report
   ##timesearch:“24 hr”
   ##searchinterval:“30 s”
Transmission Range: 1 km radius

Matthew has a license for the backend dissemination of platform data via 3rd party applications. Matthew then develops a website and an application that lets you see where the best surfing spots are at the current moment in time, how long it will be a good surfing spot for based on past data, and the historical data on those surfing spots. The website/application itself connects to Matthew's server which itself, connects to the platform directly via structured authentication, and sends pull requests for the appropriate data as per the license agreement.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for one or more subscribers to anonymously send a pull request to a server comprising the following steps:
authenticating, by a gateway server, one or more subscribers; and
evaluating, by a context server, a request by a subscriber, the evaluation comprising the following steps:
reconciling the service type of the request;
reconciling one or more groups associated with the request;
retrieving and selecting data elements based on the service type data and the one or more groups, the data elements populated by the one or more other subscribers, the data elements including at least one of subscriber location and subscriber listening range of the one or more other subscribers;
processing the data elements with a database, the processing including comparison analysis between data elements within said database; and
providing the relevant data elements to the subscriber making the request if the subscriber listening range, defined by the subscriber, overlaps with a transmission range of the relevant data elements, specified by the one or more other subscribers for each corresponding data element.

2. The method of claim 1 wherein, proximity for transmission ranges and listening ranges for the one more subscribers includes small scale range.

3. The method of claim 1 wherein, subscriber location is determined by any one of GPS, IP address, and network triangulation.

4. The method of claim 1 wherein, a request includes posting a structured data update to the one or more groups.

5. The method of claim 1 wherein, a request includes searching for one or more groups.

6. The method of claim 1 wherein, a request includes searching for one or more keywords.

7. The method of claim 1 wherein, authentication further comprises verifying subscriber ID, subscriber location, and verifying authorization for presence on current network.

8. The method of claim 1 wherein, the subscriber ID is not shared with the one or more other subscribers on network.

9. A method for one or more subscribers to anonymously send a push request to a server comprising the following steps:
authenticating, by a gateway server, one or more subscribers; and
evaluating, by a context server, a request by a subscriber, the evaluation comprising the following steps:
reconciling the service type of the request;
reconciling one or more groups associated with the request;
retrieving and selecting data elements based on the service type data and the one or more groups from the request, the data elements populated by the one or more other subscribers, the data elements including at least one of subscriber location and subscriber transmission range of the one or more other subscribers;
processing the data elements with a database, the processing including comparison analysis between data elements within said database; and
updating the database with the processed request.

10. The method of claim 9 wherein, proximity for transmission range for the one more subscribers includes small scale range.

11. The method of claim 9 wherein, subscriber location is determined by any one of GPS, IP address, and network triangulation.

12. The method of claim 9 wherein, a request includes posting a structured data update to the one or more groups.

13. The method of claim 9 wherein, a request includes searching for one or more groups.

14. The method of claim 9 wherein, a request includes searching for one or more keywords.

15. The method of claim 9 wherein, authentication further comprises verifying subscriber ID, subscriber location, and verifying authorization for presence on current network.

16. The method of claim 9 wherein, a confirmation is sent to the one or more subscribers sending the request upon the updating of the database with the processed request.
